(19) United States
(12) Patent Application Publication
(10) Pub. No.: US 2019/0176854 A1
(43) Pub. Date: Jun. 13, 2019

(54) METHOD OF ASSEMBLING A RAIL VEHICLE BODY

(71) Applicant: ALSTOM Transport Technologies, SAINT OUEN (FR)

(72) Inventor: Bernard AWTUCH, Chateau L'Abbaye (FR)

(21) Appl. No.: 16/214,775

(22) Filed: Dec. 10, 2018

(30) Foreign Application Priority Data
Dec. 13, 2017 (FR) 17 62080

(51) Int. Cl. B61D 17/04; G06F 17/50; B61D 17/12; B61D 17/08

(52) U.S. Cl. CPC B61D 17/045; B61D 17/08; B61D 17/12; G06F 17/5095

(57) ABSTRACT

A method of assembling a body of a rail vehicle includes steps of: creating a numerical model of at least one specific module; dimensioning in the numerical model, the position of fixing holes in the specific module, the dimensioning of each fixing hole being defined at least with respect to one edge of the specific module extending in a direction of greater length of the specific module and with respect to an axis transverse to the longer direction; supplying the specific module; drilling the fixing holes in the specific module by a drilling device at the position listed in the numerical model; and assembling the body, the assembly including attaching the specific module to at least one adjacent module utilizing a fixing unit inserted into the fixing holes drilled in the specific module.

### CROSS-REFERENCE TO RELATED APPLICATIONS

This application is a U.S. non-provisional application claiming the benefit of French Application No. 17 62080, filed on Dec. 13, 2017, which is incorporated herein by reference in its entirety.

### FIELD OF THE INVENTION

The present invention relates to a method of assembling a rail vehicle body, the body comprising at least one chassis module, at least one wall module and at least one roof module.

The invention applies more particularly to the bodies of railway vehicles of the tramway, metro and interregional train type.

### BACKGROUND

Railway vehicle bodies comprising one or more wall modules, one or more chassis modules, and one or more roof modules are known.

During assembly of the body, these modules are connected together, for example, by welding. However, assembly by welding is likely to cause deformation of the modules and thus makes the assembly of such bodies difficult.

To avoid deformation of the body during assembly, it is also known to connect the modules by riveting.

In order to achieve this riveting, it is known to counter-drill the rivet holes during the assembly step of the modules. This technique, however, requires the use of a complex assembly station and leads to the production of chips at the assembly stage of the modules. It is then necessary to protect the modules in this step and limit the pre-equipment of the modules.

Another known possibility is to make oblong riveting holes prior to the assembly step of the modules, thus providing a tolerance for the positioning of the riveting holes. However, this method also requires a complex assembly station, as well as the presence of several operators to maintain the modules in position in order to perform the riveting correctly, while not offering optimal assembly quality.

### SUMMARY

One object of the invention is to obtain a simplified body assembly method, while ensuring an optimized and precise assembly of the modules.

For this purpose, the object of the invention is an assembly method of the aforementioned type comprising the following steps:
creating a numerical model of at least one specific module among the chassis, wall and roof modules;
dimensioning the position of fixing holes in the specific module in the numerical model, the dimensioning of each fixing hole being defined at least with respect to a specific module edge extending in a direction of greater length of the specific module, and with respect to an axis transverse to the direction of greater length of the specific module, the transverse axis being distinct from the edges of the specific module;
supplying the specific module;
drilling, by a drilling device, of fixing holes in the specific module at the dimensioned position in the numerical model; and
assembling the body by fixing the chassis, wall and roof modules together, the assembly comprising the attachment of the specific module to at least a portion of the adjacent modules to be assembled with the specific module, by means of fasteners inserted into the fixing holes drilled in the specific module.

According to particular embodiments of the invention, the assembly method also has one or more of the following characteristics, taken in isolation or according to any technically feasible combination:
the transverse axis is a median axis of the specific module;
each of the chassis, wall and roof modules is in the form of a specific module, while the drilling step is performed individually for each specific module prior to the assembly step;
each fixing hole is drilled at a distance from the dimensioned position in the numerical model with a diameter localization tolerance of 0.25 mm;
prior to the drilling step, the assembly method comprises a step of locating the ends of the specific module in the direction of greater length of the latter, relative to a reference of the drilling device, which is advantageously a numerically controlled machine tool;
prior to the drilling step, the assembly method comprises a step of aligning the specific module, in particular with respect to areas for receiving the fixing holes; the fasteners are in the form of rivets;
the rivets are one-piece blind rivets;
prior to the step of assembling the body, the assembly method comprises a step of calculating the shear resistance of the fasteners;
the specific module is a pre-equipped module;
the assembly method comprises an additional step of connecting the modules together electrically.

### BRIEF DESCRIPTION OF THE DRAWINGS

Other features and advantages of the invention will become apparent upon reading the detailed description which follows, given solely by way of example and with reference to the appended drawings, wherein:

FIG. 1 shows an exploded view, in perspective, of a rail vehicle body;

FIG. 2 shows a view of a specific module with the dimensions of the fixing holes defined according to the invention;

FIG. 3 shows a section of a one-piece blind rivet in the disassembled position;

FIG. 4 shows a section of a one-piece blind rivet in the assembled position;

FIG. 5 shows a flowchart of the method according to the invention.

### DETAILED DESCRIPTION

In the description, the terms “on”, “under”, “above”, “below”, “upper” and “lower” are defined with respect to a direction of elevation of a rail vehicle when it is arranged on rails, i.e. a substantially vertical direction when the rail vehicle is traveling on horizontal rails. The longitudinal direction is defined by the direction of travel of the rail vehicle, while the transverse direction is the direction that is substantially perpendicular to the longitudinal direction and the direction of elevation of the rail vehicle.

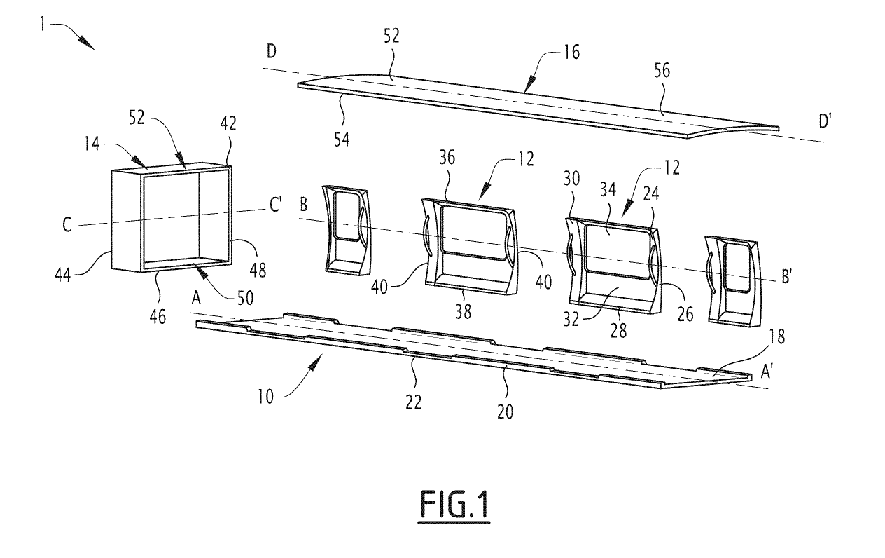

The rail vehicle body 1 shown in FIG. 1 comprises a chassis 10, wall 12, and end modules 14 and a roof module 16.

It should be noted that in FIG. 1, only the wall modules 12 of a first side of the chassis module 10 and roof module 16 are shown, while a single end module 14 is arranged at a first longitudinal end of the chassis 10 and roof 16 modules. However, the body 1 advantageously comprises other wall modules 12 (not shown) that are arranged symmetrically to the visible wall modules 12 on the opposite side of the modules 10 and 16, and another end module 14 (also not shown), arranged at a second longitudinal end of the chassis 10 and roof 16 modules opposite the first end.

Alternatively, the body 1 comprises a single wall module on each side of the chassis 10 and roof 16 modules.

The chassis 10, wall 12, end 14 and roof 16 modules define an interior space of the body 1 for receiving occupants of the railway vehicle and/or equipment.

In one example, the modules 10, 12, 14, 16 comprise electronic devices (not shown). The chassis 10, end 12, wall 14 and roof 16 modules are, for example, electrically connected to each other by connectors (not shown).

Preferably, at least one of the chassis 10, wall 12, end 14 and roof 16 modules is a pre-equipped module. Advantageously, all the chassis 10, wall 12, end 14 and roof 16 modules are pre-equipped modules.

“Pre-equipped module” is understood to mean a module comprising components assembled prior to assembly of the module to the other modules of the body 1.

A pre-equipped module is, for example, designed to be individually controlled via a control station provided for this purpose, wherein, for example, the installation and/or the correct functioning of components and/or electronic devices of the pre-equipped module is controlled.

The chassis module 10 extends in a substantially horizontal plane along a longer direction A-A′.

The greatest length of the chassis module 10, taken in the direction A-A′, is between 10 m and 20 m.

The width of the chassis module 10, in a direction orthogonal to the direction A-A′ is between 2 m and 3 m.

The chassis module 10 defines a substantially flat upper face 18 and a substantially flat lower face 20 parallel to the upper face 18.

The upper face 18 is the face of the chassis module 10 which faces the top of the body 1.

The chassis module 10 further defines at least one edge 22 extending parallel to the greater direction A-A′ along one of the upper 18 and lower 20 faces.

The chassis module 10 is arranged below the roof module 16 and is substantially perpendicular to the wall 12 and end 14 modules.

The chassis module 10 comprises, for example, a metal structure that is designed to support the weight of the occupants or equipment (not shown) of the railway vehicle.

The chassis module 10 further comprises a floor located on the upper face 18 of the structure. The floor is typically a surface that is intended to receive occupants of the railway vehicle and/or equipment of the railway vehicle.

The chassis module 10 is connected to the wall 12 and the end 14 modules.

Each wall module 12 extends in a substantially vertical plane, perpendicular to the transverse direction, along a direction of greater length B-B′. The direction B-B′ is parallel to the direction A-A′.

The length of the wall module 12, taken in the direction B-B′, is between 0.5 m and 3 m.

The height of the wall module 12 in a direction orthogonal to the direction B-B′ is between 1.7 m and 2.5 m.

Each wall module 12 defines an inner face 24 and an outer face 26 that is opposite to the inner face 24.

The inner face 24 refers to the face of the wall module 12 which is turned towards the inside of the body 1.

The wall module 12 further defines at least one edge 28 extending parallel to the greater direction B-B′ along one of the inner 24 and outer 26 faces of the wall module 12.

A first portion of the wall modules 12 together form a first side wall of the body 1, while a second portion of the wall modules 12 together form a second side wall of the body 1, wherein the first and second side walls delimit the internal space 18 transversely.

Each wall module 12 comprises a load-bearing structure comprising uprights 30 each of which connects the chassis module 10 to the roof module 16. These uprights 30 comprise, for example, door pillars each of which delimits an edge of a door formed in one of the side walls of the body 1.

Each wall module 12 further comprises at least one metal sheet 32 fixed between two uprights 30, and at least one window 34 mounted between two uprights 30, above a metal sheet 32.

Each wall module 12 comprises an upper edge 36, a lower edge 38, and longitudinal edges 40.

The upper edge 36 is connected to the roof module 16. The lower edge 38 is connected to the chassis module 10. The connections between the modules 10, 12, 16 are described in more detail below.

The longitudinal edges 40 are formed by the uprights 30. At least one of the upper 36 and lower 38 edges is defined by an edge 28.

Each end module 14 extends in a substantially vertical plane that is perpendicular to the transverse direction, along a direction of greater length C-C′. The direction C-C′ is orthogonal to the direction A-A′.

The greatest length of the end module 14, taken along the direction C-C′, is between 2 m and 3 m.

The height of the end module 14 in a direction orthogonal to the direction C-C′ is between 2 m and 2.9 m.

Each end module 14 defines an inner face 42 and an outer face 44 that is opposite the inner face 42.

The inner face 42 is referred to as the face of the end module 14 which is turned towards the inside of the body 1.

The end module 14 further defines at least one edge 46 extending along the longer direction C-C′ on either the inner face 42 or the outer face 46 of the end module 14.

Each end module 14 comprises vertical beams 48 and horizontal beams 50, 52, including a lower beam 50 and an upper beam 52.

Each of the vertical beams 48 is connected to a respective wall module 12, while the horizontal beam 50 is connected to the chassis module 10, and the horizontal beam 52 is connected to the roof module 16.

The roof module 16 extends in a substantially horizontal plane along a direction of greater length D-D′. The direction D-D′ is parallel to the direction A-A′.

The greatest length of the roof module 16, taken in the direction D-D′, is between 10 m and 20 m.

The width of the roof module 16, in a direction orthogonal to the direction D-D′ is between 2 m and 3 m.

The roof module 16 defines an upper face 52 and a lower face 54 that is opposite to the upper face 52.

The lower face 54 is the face of the chassis module 10 which faces the bottom of the body 1.

The roof module 16 further defines at least one edge 56 extending parallel to the longer length direction D-D′ along one of the upper and lower faces 52 of the roof module 16.

The roof module 16 comprises, for example, a vaulted structure and a sheet fixed to the vaulted structure (not shown).

The roof module 16 is connected to the upper edge 36 of each wall module 12 and to the upper beam 52 of each end module 14.

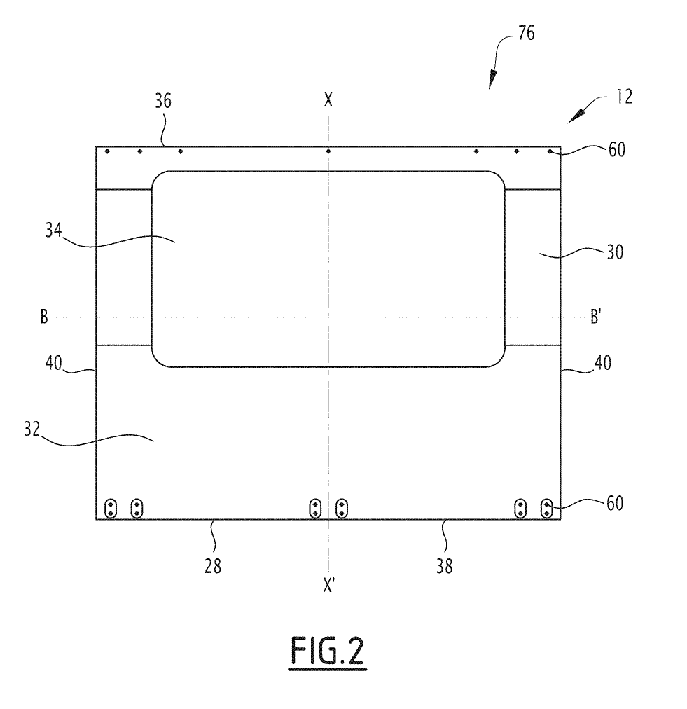

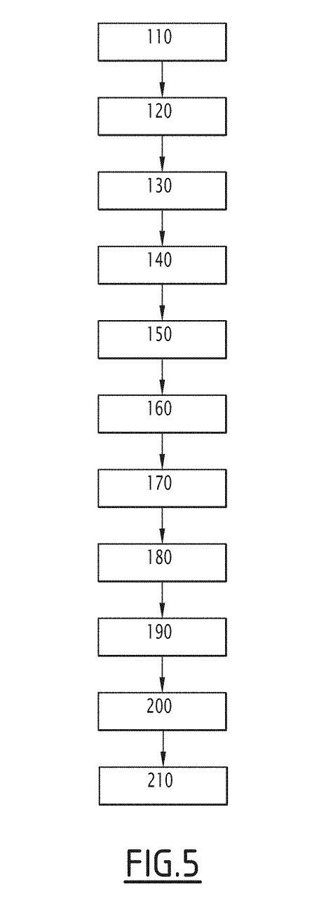

The body 1 also comprises fixing means 58 (FIG. 4) inserted into fixing holes 60 (FIG. 2) formed in the modules 10, 12, 14, 16, wherein the fastening means 58 connect the various modules 10, 12, 14, 16 between them.

In particular, in the case of each pair of adjacent modules 10, 12, 14, 16, the modules 10, 12, 14, 16 are assembled to each other by at least one fixing means 58 respectively inserted into fixing holes 60 of the modules 10, 12, 14, 16, as shown in FIG. 4.

A method of assembling the body 1, as shown in FIG. 5, will now be described.

The method of assembling the body 1 comprises a first step 110 of creating a numerical model of at least one specific module 76 among the chassis 10, wall 12, end 14 and roof 16 modules.

The numerical model is created, for example, by means of computer-aided design (CAD) software.

Advantageously, each of the chassis 10, wall 12, end 14 and roof 16 modules constitutes such a specific module 76.

The position of the fixing holes 60 in the specific module 76 is dimensioned in the numerical model during a step 120.

The dimensioning of each fixing hole 60 is defined at least with respect to an edge 22, 28, 46, 56 of the specific module 76 extending in the direction of greater length A-A′, B-B′, C-C′, D-D′ of the specific module 76 and with respect to a transverse axis X-X′ in the direction of the greater length of the specific module 76. The transverse axis X-X′ is distinct from the edges of the specific module 76.

Advantageously, the transverse axis X-X′ is a median axis of the specific module 76.

In the example shown in FIG. 2, the specific module 76 is a wall module 12. The edge 28 used for the dimensioning the fixing holes 60 of this wall module 12 is the edge 28 located on the lower edge 38 of the wall module 12.

In an advantageous embodiment, the assembly method comprises a step 130 for calculating the shear resistance of the fixing means 58.

This step 130 comprises the simulation of external forces that may apply to the body 1, and the calculation of the resulting shear applied to the fixing means 58.

Then, in a step 140, the specific module 76 is provided.

Advantageously, the assembly method comprises a step 150 of pre-equipment of the specific module, in the course of which the components of the specific module 76 are assembled.

Each specific pre-equipped module 76 is then preferably controlled by a control station. For example, the installation or correct operation of the components of the pre-equipped module is controlled.

The assembly method then advantageously comprises a step 160 of aligning the specific module 76 in order to flatten the specific module 76, in particular in the areas intended to receive the fixing holes, in particular to allow optimized assembly of the specific modules 76.

The specific module 76 is then positioned on a drilling device during the step 170.

The drilling device is advantageously a numerically controlled machine tool.

“Numerical control” is understood to mean all the hardware and software whose function is to give movement instructions to the machine tool parts, in particular to the milling head.

In particular, the numerically controlled machine tool is controlled by means of the numerical model of the specific module 76 and computer-aided manufacturing (CAM) software that defines the path to be traveled by the milling head of the machine tool.

The method then comprises the step 180 of locating the ends of the specific module 76 in the direction of greater length of the latter relative to a reference system of the numerically controlled machine tool. The numerically controlled machine tool thus knows the exact position of the specific module 76 relative to the machine.

Advantageously, the location of the ends is performed by sensors.

Then, during the step 190, the fixing holes 60 are drilled in the specific module 76 by the numerically controlled machine tool at the positions listed in the numerical model.

The milling head of the numerically controlled machine tool is first positioned at a reference axis at the edge 22, 28, 46, 56 and the transverse axis X-X′ of the specific module 76. Then the milling head moves orthogonally to the reference axis and drills the fixing holes 60 at the locations defined by the dimensioning.

The positioning error of the machine tool increases with the distance traveled by the machine tool from the reference axis. However, as the fixing holes 60 are dimensioned with respect to a median axis of the specific module 76 and not from one of the lateral edges, the positioning error is accordingly reduced. In particular for the chassis 10 and roof 16 modules that extend up to more than 15 m, the dimensioning with respect to the median transverse axis X-X′ allows a significant gain in manufacturing tolerance.

Advantageously, each fixing hole 60 is thus drilled at a distance from the dimensioned position in the numerical model with a diameter localization tolerance of 0.25 mm.

Alternatively, the pre-equipment step 150 may be carried out after the drilling step 190.

The step 190 is followed by a step 200, in the course of which the body 1 is assembled by fixing the chassis 10, wall 12, end 14 and roof 16 modules to each other.

This assembly comprises the fixing of the specific module 76 to its adjacent modules by means of the fixing means 58, which are inserted into the fixing holes 70 drilled in the specific module 76.

Advantageously, the fixing means 58 used for this purpose are dimensioned to withstand the shear stresses calculated during step 130, throughout the planned life of the body 1.

Moreover, these fixing means 58 are preferably in the form of rivets 62.

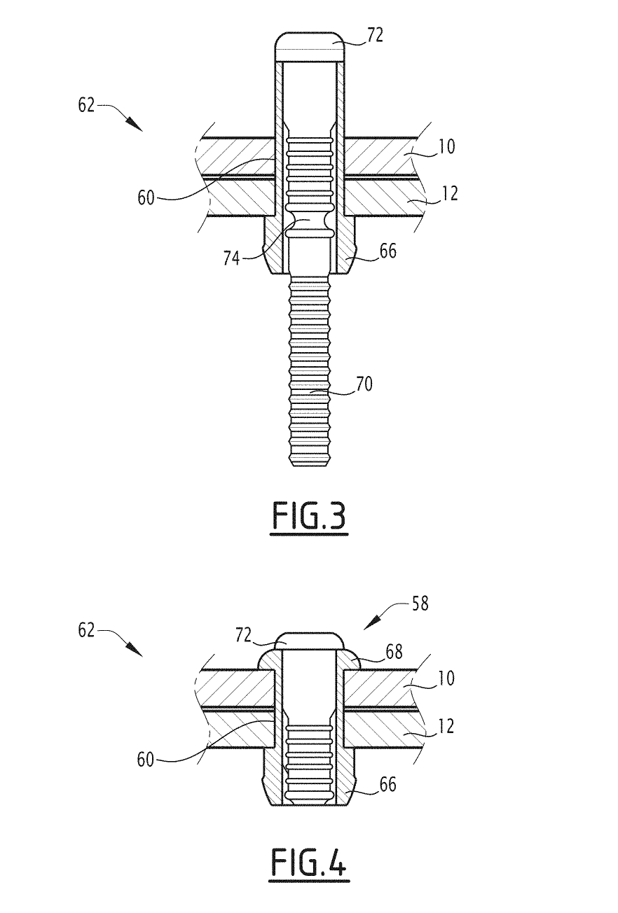

When these rivets 62 are provided for insertion into the fixing holes 60, they are still in a disassembled configuration as shown in FIG. 3, wherein they are remote from the fixing holes 60. Each rivet 62 therefore only comprises a cylindrical portion 64 that is designed to be inserted into a fixing hole 60, and wherein a first head 66 has a radial extension greater than the diameter of the fixing hole 60.

Then, the cylindrical portion 64 of each rivet 62 is inserted into the fixing holes 60 of at least two separate modules 10, 12, 14, 16, and is deformed in order to form at the second end of the cylindrical portion 64 a second head 68 with a radial extension that is larger than the diameter of the fixing holes 60, and wherein the two heads 66, 68 are located outside the fixing holes 60, thus making it possible to secure the two modules 10, 12, 14, 16 together. The rivet 62 is then in an assembled configuration, as shown in FIG. 4.

Advantageously, each rivet 62 is a one-piece blind rivet.

In the disassembled position, as illustrated in FIG. 3, the rivet 62 then comprises, in addition to the cylindrical portion 64 and the first head 66, a rod 70 introduced into the cylindrical portion 64, wherein the first end of the rod 70 protrudes out of the first head 66.

This rod 70 comprises a head 72 that is arranged at the second end of the rod 70. The head 72 has a radial extension greater than the diameter of the cylindrical portion 64. The rod 70 further comprises an area of weakness 74.

When the rivet 62 has been inserted into a hole 60, the rod 70 is pulled out of the cylindrical portion 64 through the first head 66, for example by means of a hydraulic rivet pliers. This has the effect that the head 72 of the rod 70 deforms the second end of the cylindrical portion 64 to allow the formation of the second head 68 as shown in FIG. 4. When the second head 68 is formed, the rod 70 breaks at the lower area of weakness 74, and the portion opposite the head 72 of the rod 70 is withdrawn from the cylindrical portion 64.

The assembly of the rivet 62 is thus carried out by manipulating the rivet 62 only on one side of the modules 10, 12, 14, 16 thus making assembly with the one-piece blind rivet 62 fast and simple.

The method comprises a final step 210 of electrical connection of the modules 10, 12, 14, 16 to each other. This connection is typically made by direct connection of connectors integrated in the modules 10, 12, 14, 16.

The assembly method described above allows a simple assembly of the modules, and therefore a simplified assembly station.

In fact, the drilling of the fixing holes 60 is performed on each module separately before the assembly step to facilitate both drilling and assembly.

Moreover, thanks to the numerical model and to the particular dimensioning of the fixing holes, the coaxiality of the fixing holes 60 is guaranteed with very great precision, which also allows optimization of the number of rivets 62 required for the assembly of the body 1.

In addition, this assembly method does not produce chips during assembly, thus making it possible to further equip the modules 10, 12, 14, 16.

The assembly method also does not require the use of a sealing mastic between the modules 10, 12, 14, 16 because of the accuracy of the positioning of the fixing holes 60 and thus good interaction between the adjacent modules.

The assembly method described thus allows a simple and precise assembly of the modules 10, 12, 14, 16.

1. Method of assembling a body of a rail vehicle, the body comprising at least one chassis module, at least one wall module and at least one roof module, the method comprising:
creating a numerical model of at least one specific module among the chassis, wall and roof modules;
dimensioning in the numerical model, the position of fixing holes in the specific module, the dimension of each fixing hole being defined at least with respect to one edge of the specific module extending in a direction of greater length of the specific module, and with respect to an axis transverse to the longer direction-of the specific module, the transverse axis being distinct from the edges the specific module;
providing the specific module;
drilling with a drilling device, fixing holes in the specific module at the dimensioned position in the numerical model; and
assembly of the body by fixing the chassis, wall and roof modules together, the assembly comprising the fixing of the specific module to at least one portion of adjacent modules that are to be assembled with the specific module, by means of fixing means inserted in the fixing holes that have been drilled in the specific module.

2. Method of assembly according to claim 1, wherein the transverse axis is a median axis of the specific module.

3. Method of assembly according to claim 1, wherein each of the chassis, wall and roof modules forms a specific module, and wherein the drilling step is performed individually for each specific module prior to the assembly step.

4. Method of assembly according to claim 1, wherein each fixing hole is drilled at a distance from the position dimensioned in the numerical model with a diameter localization tolerance of 0.25 mm.

5. Method of assembly according to claim 1, comprising, prior to the drilling step, a step of locating ends of the specific module in the direction of the greater length of the latter, relative to a reference system of the drilling device, which is advantageously a numerically controlled machine tool.

6. Method of assembly according to claim 1, comprising, prior to the drilling step, a step of flattening the specific module in particular in areas intended to receive the fixing holes.

7. Method of assembly according to claim 1, wherein the fixing means are in the form of rivets.

8. Method of assembly according to claim 7, wherein the rivets are one-piece blind rivets.

9. Method of assembly according to claim 1, comprising, prior to the assembly step of the body, a step for calculation of the shear resistance of the fixing means.

10. Method of assembly according to claim 1, wherein the specific module is a pre-equipped module.

11. Method of assembly according to claim 1, comprising an additional step of electrical connection of the modules to each other.

12. Method of assembly according to claim 2, wherein each of the chassis, wall and roof modules forms a specific module, and wherein the drilling step is performed individually for each specific module prior to the assembly step.

13. Method of assembly according to claim 2, wherein each fixing hole is drilled at a distance from the position dimensioned in the numerical model with a diameter localization tolerance of 0.25 mm.

14. Method of assembly according to claim 3, wherein each fixing hole is drilled at a distance from the position dimensioned in the numerical model with a diameter localization tolerance of 0.25 mm.

15. Method of assembly according to claim 2, comprising, prior to the drilling step, a step of locating ends of the specific module in the direction of the greater length of the latter, relative to a reference system of the drilling device, which is advantageously a numerically controlled machine tool.

16. Method of assembly according to claim 3, comprising, prior to the drilling step, a step of locating ends of the specific module in the direction of the greater length of the latter, relative to a reference system of the drilling device, which is advantageously a numerically controlled machine tool.

17. Method of assembly according to claim 4, comprising, prior to the drilling step, a step of locating ends of the specific module in the direction of the greater length of the latter, relative to a reference system of the drilling device, which is advantageously a numerically controlled machine tool.

18. Method of assembly according to claim 2, comprising, prior to the drilling step, a step of flattening the specific module in particular in areas intended to receive the fixing holes.

19. Method of assembly according to claim 3, comprising, prior to the drilling step, a step of flattening the specific module in particular in areas intended to receive the fixing holes.

20. Method of assembly according to claim 4, comprising, prior to the drilling step, a step of flattening the specific module in particular in areas intended to receive the fixing holes.
